(19) United States
(12) Patent Application Publication
(10) Pub. No.: US 2011/0185832 A1
(43) Pub. Date: Aug. 4, 2011

(54) Wind Power Plant Transmission and Auxiliary Drive for a Wind Power Plant Transmission

(75) Inventors: Horst Dammer, Wesel (DE); Marc Semelka, Rees (DE); Johannes Vriesen, Bocholt (DE)

(73) Assignee: Winergy AG, Voerde (DE)

(21) Appl. No.: 13/061,334

(22) PCT Filed: Jul. 29, 2009
(86) PCT No.: PCT/EP2009/059796

§ 371 Date: Apr. 8, 2011

(30) Foreign Application Priority Data
Aug. 29, 2008 (DE) 10 2008 044 900.8

(51) Int. Cl. F16H 3/08

(52) U.S. Cl. 74/325

(57) ABSTRACT

A wind power plant transmission with at least one transmission stage which comprises at least a first and a second gearwheel, wherein a third gearwheel is provided which is connected axially to and is centered on the first or second gearwheels. At least the first, second and third gearwheels are encompassed by a transmission housing. Flange-mounted on the transmission housing is an auxiliary drive, where the torque of the auxiliary drive can be transmitted to the third gearwheel by a fourth gearwheel which is movable axially along, and can rotate with, a driveshaft which is driven by a motor. In an activated state of the auxiliary drive, the third gearwheel is in engagement with the fourth gearwheel. By omitting a front-mounted gearing and thereby reducing the number of individual parts, it is possible for a wind power plant transmission to be obtained in a more cost-effective and more compact manner.

### CROSS-REFERENCE TO RELATED APPLICATIONS

This is a U.S. national stage of International Application No. PCT/EP2009/059796, filed on 29 Jul. 2009. This patent application claims the priority of German Patent Application No. 10 2008 044 900.8, filed 29 Aug. 2008, the entire content of which application is incorporated herein by reference.

### BACKGROUND OF THE INVENTION

1. Field of the Invention

The present invention is directed to a transmission or gearboxes and, more particularly, to a wind power installation gearbox and auxiliary drive for a wind power installation gearbox.

2. Description of the Related Art

For maintenance or inspection of a wind power installation, it is often necessary to rotate a wind power installation drive train which has a gearbox and generator. In the case of relatively large wind power installations, rotation of the drive train by human muscle power is normally no longer possible particularly because of high inertia moments resulting from large rotor diameters. In prior solutions, an auxiliary drive which is connected to the wind power installation gearbox via an additional input gearbox is used for this purpose. This is disadvantageous for space, weight and cost reasons. In particular, a design change to a pod of a wind power installation because of an increased space requirement resulting from a gearbox equipped with an auxiliary drive and input gearbox is extremely complex and expensive.

### SUMMARY OF THE INVENTION

It is therefore an object of the present invention to provide a maintenance-friendly and inspection-friendly industrial gearbox which allows a space-saving, minimized-weight design, and can be produced at low cost.

This and other objects and advantages are achieved in accordance with the invention by a wind power installation gearbox and by an auxiliary drive for a wind power installation gearbox having at least one gearbox stage which comprises at least one first gearwheel and one second gearwheel. In addition, a third gearwheel is provided, which is axially connected to the first gearwheel or the second gearwheel and is centered thereon. At least the first, the second and the third gearwheels are surrounded by a gearbox housing. An auxiliary drive is flange-connected to the gearbox housing and its torque can be transmitted to the third gearwheel by a fourth gearwheel which can be moved axially along a drive shaft, which is driven by a motor, and which fourth gearwheel can thus be rotated by the drive shaft. When the auxiliary drive is connected, the third gearwheel engages with the fourth gearwheel. A wind power installation gearbox can be provided which costs less and is more compact because of the lack, in accordance with the invention, of an input gearbox and a reduction in the resultant number of individual parts.

The fourth gearwheel is preferably moved along the drive shaft of the auxiliary drive by a lever mechanism. Furthermore, the lever mechanism may comprise an adjusting lever, which is secured against inadvertent operation by a positioning bolt which can be latched in, thus reducing the risk of control errors. The positioning bolt advantageously has a spring mechanism to return the positioning bolt to an axial rest position.

In accordance with a further embodiment of the present invention, the adjusting lever can be moved by a return spring to a rest position in which torque transmission between the auxiliary drive and the first or second gearwheel of the epicyclic stage is interrupted. In this way, the first gearwheel is automatically returned to an initial position after use of the auxiliary drive, in which initial position it no longer engages with the second gearwheel. In combination with the positioning bolt, which comprises the above spring mechanism, automatically returning the adjusting lever offers an advantage, with regard to safety at work with appropriate dimensioning, that two operators are required for starting the motor of the auxiliary drive. In this case, a first operator operates the adjusting lever, and a second operator operates a switch, which is physically remote from this, for starting the motor.

An electromagnetic limit switch is preferably provided for detection of connection of the auxiliary drive by operation of the adjusting lever, which limit switch can be switched by the adjusting lever and is connected to a wind power installation control unit. As a result, it is possible to avoid damage caused by the wind power installation being started up when the third and fourth gearwheels for the auxiliary drive are still engaged with one another.

The electromechanical limit switch is advantageously connected to the adjusting lever by a guide disk, which has a radial cutout for operation of the electromechanical limit switch. Here, the guide disk can be rotated by operation of the adjusting lever. If the guide disk is designed appropriately, the electromechanical limit switch and the adjusting lever in combination with the positioning bolt, which comprises the above spring mechanism, are separated. Consequently, damage to or manipulation of the positioning bolt normally does not necessarily lead to measures for protection of the auxiliary drive against being started up inadvertently being rendered ineffective, provided that the limit switch is still serviceable as a redundant safety apparatus. By way of example, the limit switch can be configured to produce a switch-off signal for the wind power installation control unit.

In accordance with a further embodiment of the present invention, a movement of the adjusting lever can be transmitted by a shaft to a guide lever which is rigidly coupled to the adjusting lever. In addition, a gripper, which clasps the fourth gearwheel, is arranged at a free end of the guide lever. Here, the fourth gearwheel can be moved axially along the drive shaft of the auxiliary drive by the gripper. As a result, it becomes possible to provide a mechanically reliable movement mechanism for the fourth gearwheel.

Preferably, the first and the second gearwheels have helical tooth systems, and the third and the fourth gearwheels have straight tooth systems. Furthermore, the fourth gearwheel may have chamfers or rounded areas on one or both flanks, thus allowing the fourth gearwheel to be moved axially, and to be easily engaged with the third gearwheel.

In accordance with a preferred embodiment of the present invention, the motor has a motor shaft which runs at right angles to the drive shaft and is coupled to it. In addition, the gearbox stage is an epicyclic or spur-gear gearbox stage. This results in a particularly space-saving arrangement of the auxiliary drive, which does not disadvantageously increase the axial extent of the wind power installation gearbox. Furthermore, the third gearwheel is preferably arranged in a space-saving manner axially between the first gearwheel or the second gearwheel and a gearbox bearing on the generator side, which is surrounded by the gearbox housing.

The auxiliary drive, in accordance with an embodiment of the invention, for a wind power installation gearbox, which has at least one first gearwheel and one second gearwheel, can be flange-connected to a gearbox housing which surrounds the first and the second gearwheel, and a third gearwheel which is axially connected to the first gearwheel or the second gearwheel and is centered thereon.

In addition, the auxiliary drive has a fourth gearwheel, which can be moved axially along a drive shaft that is driven by a motor of the auxiliary drive, which fourth gearwheel can rotate with the drive shaft and engages with the third gearwheel when the auxiliary drive is in a connected state.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail in the following text using one exemplary embodiment and with reference to the drawing, in which:

FIG. 1 is a perspective illustration of a wind power installation gearbox with an auxiliary drive;

FIG. 2 is a perspective illustration of components of the wind power installation gearbox, arranged in a gearbox housing, shown in FIG. 1;

FIG. 3 is a detailed illustration of a lever mechanism for connection of the auxiliary drive; and

FIG. 4 shows a sectional illustration of the lever mechanism shown in FIG. 3.

### DETAILED DESCRIPTION OF THE PREFERRED EMBODIMENTS

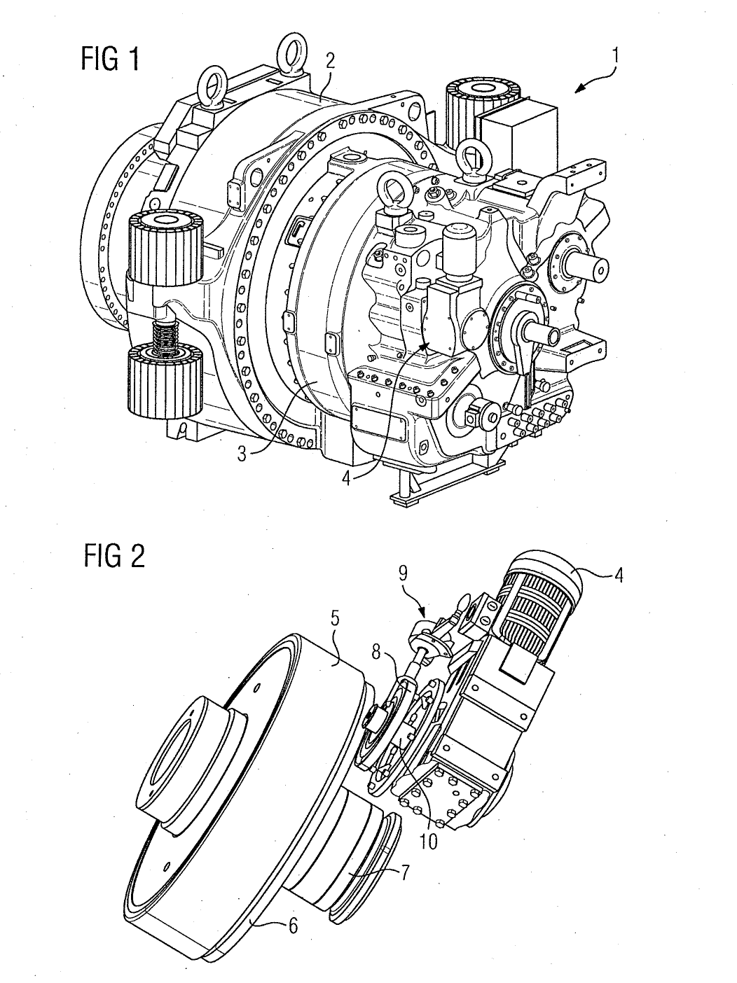

The wind power installation gearbox 1 illustrated in FIG. 1 has a rotor-side epicyclic gearbox stage 2 and a spur-gear gearbox stage 3 on the generator side. The spur-gear gearbox stage 3 has a first gearwheel 5 on the input drive side, and a second gearwheel on the output drive side. As shown in FIG. 2, a third gearwheel 6 is connected axially to the first gearwheel 5, and is centered thereon. The spur-gear gearbox stage furthermore has a gearbox housing, which surrounds the first gearwheel 5, the second and third gearwheels 6 and a gearbox bearing 7 on the generator side. The third gearwheel 6 is arranged axially between the first gearwheel 5 and the gearbox bearing 7. An auxiliary drive 4 is flange-connected to the gearbox housing of the spur-gear gearbox stage 3 and its torque can be transmitted to the third gearwheel 6 by a fourth gearwheel 8, which can be moved axially along a drive shaft 10 which is driven by a motor, and which fourth gearwheel 8 can rotate with the drive shaft 10. The fourth gearwheel 8 can be moved axially by a lever mechanism 9 and engages with the third gearwheel 6 when the auxiliary drive 4 is in a connected state. When the third gearwheel 6 and the fourth gearwheel 8 are engaged with one another, a drive train, which comprises the epicyclic gearbox stage 2 and the spur-gear gearbox stage 3, can be rotated for maintenance or inspection purposes.

The use of the present invention is not restricted to coupling an auxiliary drive to a spur-gear gearbox. For example, the third gearwheel 6 can also be coupled to a sun wheel of an epicyclic gearbox.

The first gearwheel 5 and the second gearwheel of the spur-gear gearbox stage 3 preferably have helical tooth systems, while the third gearwheel 6 and the fourth gearwheel 8 have straight tooth systems, in order to allow the two gearwheels to engage more easily during axial movement of the fourth gearwheel 8. For this reason, the fourth gearwheel 8 also has chamfers or rounded areas on one or both flanks. Since only relatively small torques are transmitted by the third gearwheel 6 and the fourth gearwheel 8, in comparison to the first gearwheel 5 and the second gearwheel, there is no need for a relatively complex helical tooth system for the third gearwheel 6 and the fourth gearwheel 8. Furthermore, there is no need to compensate for any axially acting force components with a straight tooth system.

Furthermore, the motor of the auxiliary drive 4 has a motor shaft which extends at right angles to the drive shaft 10 and is coupled to it. This allows the auxiliary drive 4 to be arranged in a space-saving manner transversely with respect to the gearbox axis, as a result of which the auxiliary drive 4 results at most in an insignificant, non-critical increase in the axial extent of the wind power installation gearbox 1.

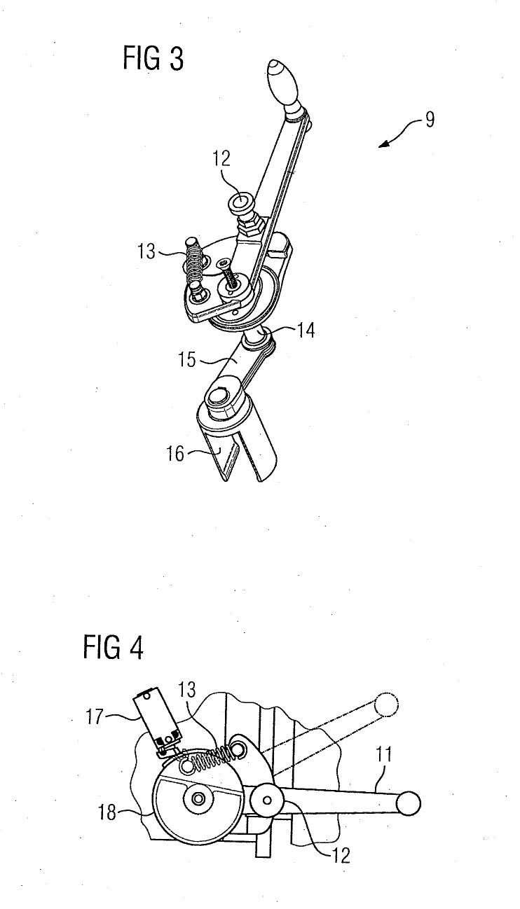

As can be seen in the detail in FIG. 3, the lever mechanism 9 has an adjusting lever 11 which is secured against inadvertent operation by a positioning bolt 12 which can be latched in. The positioning bolt 12 in turn has a spring mechanism for returning the positioning bolt 12 to an axial rest position. This precludes inadvertent operation of the adjusting lever 11, since it is locked in terms of adjustment, by the positioning bolt 12 being returned.

The adjusting lever 11 can be moved by a return spring 13 to a rest position in which torque transmission between the auxiliary drive 4 and the spur-gear gearbox stage 3 is interrupted. Movement of the adjusting lever 11 is transmitted by a shaft 14 to a guide lever 15, which is rigidly coupled to the adjusting lever 11. A gripper 16, which clasps the fourth gearwheel 8, is attached to a free end of the guide lever 15. The gripper 16 is used to move the fourth gearwheel 8 axially along the drive shaft 10 of the auxiliary drive 4. Auxiliary drive rotation is transmitted to the fourth gearwheel 8 by a radial interlock between the drive shaft 10 and the fourth gearwheel 8.

Furthermore, an electromagnetic limit switch 17, which is illustrated in FIG. 4, is provided for detection of connection of the auxiliary drive 4 as a result of operation of the adjusting lever 11. The limit switch 17 can be switched by the adjusting lever 11, such that the position of the adjusting lever 11 can be determined. In addition, the limit switch 17 is connected to a control unit, which is not illustrated explicitly in the figures but which can be used to block a wind power installation from being started up impermissibly, in order to prevent damage resulting from a connected auxiliary drive.

The electromechanical limit switch 17 is connected to the adjusting lever 11 by a guide disk 18 which, on its circumference, has a radial cutout for operation of the electromechanical limit switch 17. The guide disk 18 can be rotated by operation of the adjusting lever 11. A switching element, which interacts with the cutout, on the electromechanical limit switch 17 can be deflected by the radial cutout, thus opening and closing the electromechanical limit switch 17.

The use of the present invention is not restricted to the described exemplary embodiment.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-13. (canceled)

14. A wind power installation gearbox, comprising:
at least one gearbox stage comprising a first gearwheel and a second gearwheel;
a third gearwheel axially connected to and centered on one of the first gearwheel and the second gearwheel;
a gearbox housing surrounding the first, second and third gearwheels;
an auxiliary drive flange-connected to the gearbox housing, the auxiliary drive having a fourth gearwheel which is rotatable with a drive shaft and movable axially along the drive shaft, and a motor, the drive shaft being driven by the motor, and
the motor of the auxiliary drive having a torque which is transmittable to the third gearwheel by the fourth gearwheel when the auxiliary drive is in a connected state, the third gearwheel engaging with the fourth gearwheel when the auxiliary drive is in the connected state.

15. The wind power installation gearbox as claimed in claim 14, wherein the fourth gearwheel is moveable along the drive shaft by a lever mechanism.

16. The wind power installation gearbox as claimed in claim 15, wherein the lever mechanism comprises an adjusting lever which is securable against inadvertent operation by a latchable positioning bolt.

17. The wind power installation gearbox as claimed in claim 16, wherein the positioning bolt includes a spring mechanism for returning the positioning bolt to an axial rest position.

18. The wind power installation gearbox as claimed in claim 16, wherein the adjusting lever is moveable by a return spring to a rest position in which torque transmission between the auxiliary drive and the first gearwheel or the second gearwheel is interrupted.

19. The wind power installation gearbox as claimed in claim 17, wherein the adjusting lever is moveable by a return spring to a rest position in which torque transmission between the auxiliary drive and the first gearwheel or the second gearwheel is interrupted.

20. The wind power installation gearbox as claimed in claim 16, further comprising:
an electromagnetic limit switch detecting connection of the auxiliary drive by operation of the adjusting lever, the electromagnetic limit switch be switchable by the adjusting lever and being connected to a wind power installation control unit.

21. The wind power installation gearbox as claimed in claim 20, wherein the electromechanical limit switch is connected to the adjusting lever by a guide disk having a radial cutout for operation of the electromechanical limit switch, the guide disk being rotatable by operation of the adjusting lever.

22. The wind power installation gearbox as claimed in claim 20, wherein the electromechanical limit switch is configured to produce a switch-off signal for the wind power installation control unit.

23. The wind power installation gearbox as claimed in claim 16, wherein a movement of the adjusting lever is transmittable by a shaft to a guide lever which is rigidly coupled to the adjusting lever,
wherein a gripper, which clasps the fourth gearwheel, is arranged at a free end of the guide lever; and
wherein the fourth gearwheel is moveable axially along the drive shaft of the auxiliary drive by the gripper.

24. The wind power installation gearbox as claimed in claim 14, wherein the first and second gearwheels have a helical tooth system, wherein the third and the fourth gearwheels have a straight tooth system, and wherein the fourth gearwheel has chamfers or rounded areas on one or both flanks.

25. The wind power installation gearbox as claimed in claim 14, wherein the motor has a motor shaft which extends at right angles to the drive shaft and is coupled to the drive shaft; and wherein the at least one gearbox stage is an epicyclic gearbox stage or spur-gear gearbox stage.

26. The wind power installation gearbox as claimed in claim 25, wherein the third gearwheel is arranged axially between the first gearwheel or the second gearwheel and a gearbox bearing on a generator side which is surrounded by the gearbox housing.

27. An auxiliary drive for a wind power installation gearbox, the wind power installation gearbox having first and second gearwheels and a gearbox surrounding the first and second gearwheels, and a third gearwheel which is axially connected to and centered on one of the first gearwheel and the second gearwheel, the auxiliary drive being flange-connectable to the gearbox housing and comprising:
a drive shaft;
a motor, the drive shaft being driven by the motor; and
a fourth gearwheel which is moveable axially along the drive shaft, the fourth gearwheel being rotatable with the drive shaft and engaging the third gearwheel when the auxiliary drive is in a connected state.
